(19) United States
(12) Patent Application Publication
(10) Pub. No.: US 2018/0195701 A1
(43) Pub. Date: Jul. 12, 2018

(54) LIGHTING MODULE AND LIGHTING DEVICE COMPRISING THE LIGHTING MODULE

(71) Applicant: PHILIPS LIGHTING HOLDING B.V., EINDHOVEN (NL)

(72) Inventor: Johannes Gerrit Jan BEIJER, EINDHOVEN (NL)

(21) Appl. No.: 15/741,978

(22) PCT Filed: Jul. 6, 2016
(86) PCT No.: PCT/EP2016/065961

§ 371 Date: Jan. 4, 2018

(30) Foreign Application Priority Data
Jul. 9, 2015 (EP) 15176143.4

(51) Int. Cl. F21V 21/14; F21K 9/90; F21K 9/232

(52) U.S. Cl. CPC F21V 21/14; F21Y 2107/70; F21K 9/232; F21K 9/90

(57) ABSTRACT

A lighting module (10) is disclosed, comprising a first carrier substrate (1) and a lighting unit (2, 4a-4d). The first carrier substrate (1) is bendable. The first carrier substrate (1) is bent so as to form a tubular structure (5), which is elongated and possibly at least in part hollow, and has a central, longitudinal axis (LA). At least a portion of one side of the first carrier substrate (1) at least in part constitutes an outer surface (6) of the tubular structure (5) exhibiting a plurality of surface portions (6a-6d), with the plurality of surface portions (6a-6d) configured such that at least some of the surface portions (6a-6d) each has a surface normal (7a, 7d) that is at an angle with respect to planes perpendicular to the central, longitudinal axis (LA) and passing through the respective surface portion (6a-6d). The lighting unit (2, 7d 4a-4d) is coupled to the at least a portion of the one side of the first carrier substrate (1). By way of the geometrical configuration of the plurality of surface portions (6a-6d), the lighting unit (2, 4a-4d) and possibly at least one light-emitting element (4a-4d) included therein may have a main direction of light emission that is at an angle with respect to a plane that is passing through the tubular structure (5) and that is substantially perpendicular to the central, longitudinal axis (LA) of the tubular structure (5).

### TECHNICAL FIELD

The present invention generally relates to the field of lighting equipment and lighting devices. Specifically, the present invention relates to a lighting module for use in a lighting device and a lighting device comprising the lighting module.

### BACKGROUND

The use of light-emitting diodes (LEDs) for illumination purposes continues to attract attention. Compared to incandescent lamps, fluorescent lamps, neon tube lamps, etc., LEDs provide numerous advantages such as a longer operational life, reduced power consumption, an increased efficiency related to the ratio between light energy and heat energy, etc. Solid state based light sources such as LED based light sources may have different optical characteristics compared to incandescent light sources. In particular, solid state based light sources may provide a more directed light distribution and a higher (i.e. cooler) color temperature compared to incandescent light sources. Therefore, efforts have been made in order to make solid state based lighting devices mimic or resemble traditional incandescent lighting devices, e.g. with respect to light distribution and/or color temperature. In bulb lighting devices based on LEDs, commonly referred to as “retrofit lamps” since these LED lamps are often designed to have the appearance of a traditional incandescent light bulb and to be mounted in conventional sockets, etc., the light emitting filament wire is replaced with one or more LEDs. The atmosphere within the bulb is generally air. However, cooling of the LEDs may pose a problem in LED based retrofit lamps. Overheating of LEDs can lead to reduced lifetime, decreased light output or failure of the LEDs.

In US 2013/0301252 a retrofit lamp is disclosed comprising a LED array mounted to the board that supports the lamp electronics. Further the lamp comprises a gas filled enclosure to provide the thermal coupling to the LED array.

JP 2010141200 discloses a retrofit lamp with several LED chips mounted on substrates that also hold the circuit pattern. The substrates are arranged on a sheet structure that is folded such that the LED chips are exposed to the outer side.

EP 2781831 describes a retrofit lamp with an airflow path through the lamp via ventilation holes. The LEDs are mounted on a second cover on an outside of the thermal base and configured to dissipate heat by the air flowing through the air flow path.

### SUMMARY

In one lighting device architecture for realizing a LED bulb or retrofit lamp, the LEDs are mounted onto the outside of a tubular structure or carrier with open ends which tubular carrier is arranged within an envelope, e.g. in the form of a bulb, which for example may be made of glass or ceramic. Such a tubular carrier may generally be referred to as an elongated hollow structure having one or more open ends, which structure for example may be cylindrical, conical, truncated conical, funnel-shaped, etc., and may for example have a circular, triangular, rectangular, etc., cross-section. The bulb or lamp may in alternative or in addition be based on a type of solid state light source other than LEDs. The tubular carrier is usually placed inside the bulb with a longitudinal axis of the tubular carrier for example being parallel or coincident with an axis of symmetry of the envelope or bulb. The tubular carrier provides functionality similar to that of a chimney, allowing a fluid (or gas) flow through the tubular carrier, thereby facilitating cooling of the tubular carrier and the LEDs by way of convection taking place within the chimney (i.e. heat generated by the LEDs is transferred to fluid within the tubular carrier, thereby creating a convection flow of fluid within and through the tubular carrier). Although such a chimney configuration or architecture may provide a relatively high efficiency of heat transport away from the LEDs, it may not be able to realize a uniform light intensity distribution from the LED bulb or retrofit lamp which resembles a traditional incandescent light bulb. For example, a LED bulb or retrofit lamp based on such a chimney configuration or architecture may exhibit a region or ‘spot’ on the outer surface of the bulb, corresponding to a relatively low intensity of light. Such a ‘dark’ region or ‘spot’ may be visible to a viewer, which may not be desired. In case the envelope or bulb has a diffuse coating on the inside of the envelope or bulb walls, occurrence of such a ‘dark’ region or ‘spot’ on the envelope or bulb may be eliminated or reduced by making the diffuse coating less transparent. However, this may at the same time result in a decrease in the optical efficiency of the LED bulb or retrofit lamp.

In view of the above, a concern of the present invention is to provide a lighting module or lighting device which facilitates or allows for achieving a more uniform distribution of intensity of light emitted by the lighting module or lighting device as compared to utilizing a chimney configuration or architecture as described in the foregoing.

A further concern of the present invention is to provide a lighting module or lighting device which facilitates or allows for achieving a more uniform distribution of intensity of light emitted by the lighting module or lighting device as compared to utilizing a chimney configuration or architecture as described in the foregoing, and which further allows or facilitates for a relatively high or optical efficiency.

To address at least one of these concerns and other concerns, a lighting module and a method of manufacturing a lighting module in accordance with the independent claims are provided. Preferred embodiments are defined by the dependent claims.

With reference to the lighting device architecture example for realizing a LED bulb or retrofit lamp described above, which architecture employs a tubular carrier where at least one LED or another type of solid state light source is mounted or coupled to the outside of the tubular carrier, one or more embodiments of the present invention are based on arranging the LED(s) (or another type of solid state light source) at a tilt angle with respect to the longitudinal axis of the tubular carrier. By arranging the LED(s) (or another type of solid state light source) at a tilt angle with respect to the longitudinal axis of the tubular carrier, it may become possible for the LED(s) to emit at least some light directly onto the region or ‘spot’ on the envelope or bulb where otherwise there would be a relatively low intensity of light. Thereby, occurrence of such a ‘dark’ region or ‘spot’ on the envelope or bulb may be eliminated or reduced. And this may be achieved without having to make any diffuse coating on the inside of the envelope or bulb walls less transparent, which as mentioned above may lead to a decrease in the optical efficiency of the LED bulb or retrofit lamp.

According to a first aspect, there is provided a lighting module comprising a first carrier substrate, which is bendable and/or flexible. The lighting module comprises a lighting unit coupled to at least a portion of one side of the first carrier substrate. The first carrier substrate is or has been bent so as to form a tubular structure, wherein the tubular structure is elongated, possibly at least in part hollow, and has a central, longitudinal axis. The first carrier substrate is or has been bent such that the at least a portion of the one side of the first carrier substrate at least in part constitutes an outer surface of the tubular structure which exhibits a plurality of surface portions, the plurality of surface portions configured such that at least some of the surface portions each has a surface normal that at an angle with respect to planes perpendicular to the central, longitudinal axis and passing through the respective surface portion.

The lighting unit may be at least in part flexible. The lighting unit may for example comprise a second carrier substrate, which is flexible. The second carrier substrate may have a first side and a second side opposite to the first side. The first side may be coupled to at least a portion of one side of the first carrier substrate. The second side may be configured to couple at least one light-emitting element thereto.

In alternative or in addition, the lighting unit may for example comprise at least one electrically conductive track or trace, e.g. including conductive ink such as known in the art, which electrically conductive track or trace may be directly or indirectly (e.g. via some intermediate component) coupled to the first carrier substrate using a technique as known in the art. The at least one electrically conductive track or trace may be configured so as to be flexible, and so as to allow for bending the at least one electrically conductive track or trace without breaking it. The at least one electrically conductive track or trace may at least be coupled to the at least a portion of one side of the first carrier substrate. The lighting unit may further at least one light-emitting element coupled to the at least one electrically conductive track or trace and/or to the at least a portion of one side of the first carrier substrate.

It is to be understood that the above-described possible configurations of the lighting unit are according to exemplifying embodiments of the present invention, and that other configurations of the lighting unit are possible.

Thus, the lighting unit is coupled to the at least a portion of one side of the first carrier substrate which at least in part constitutes the outer surface of the tubular structure which exhibits the plurality of surface portions. For example, the at least one light-emitting element may be coupled to the second side of the second carrier substrate, with the second side being opposite to the first side of the second carrier substrate that is coupled to the at least a portion of one side of the first carrier substrate which at least in part constitutes the outer surface of the tubular structure which exhibits the plurality of surface portions. Thereby, the lighting unit (and possibly at least one light-emitting element included therein) becomes arranged on a surface portion of the outer surface of the tubular structure having a surface normal that is at an angle with respect to a plane perpendicular to the central, longitudinal axis and passing through the surface portion. Such a configuration of the tubular structure, i.e. so as to exhibit such a plurality of surface portions, allows or facilitates for an optical axis of the lighting unit or the at least one light-emitting element to be arranged at an angle with respect to a plane perpendicular to the central, longitudinal axis and passing through the surface portion, or tubular structure. That is to say, the lighting unit or the at least one light-emitting element may have a main direction of light emission that is tilted, or at an angle, with respect to a plane that is passing through the tubular structure and that is perpendicular (or substantially perpendicular) to the central, longitudinal axis of the tubular structure. Thereby, it may be facilitated or enabled to obtain a lighting module capable of emitting light not (only) primarily along an optical axis or optical axes lying in a plane which is (substantially) perpendicular to the central, longitudinal axis of the tubular structure, but (also) along an optical axis or optical axes which are not lying in that plane but arranged at angles with respect to that plane, for example so as point generally towards a first (or upper) end of the tubular structure, and/or towards a second (or lower) end of the tubular structure. In case the optical module includes several light-emitting elements, which for example may be arranged substantially circumferentially around the lighting module, the lighting module may provide a relatively high uniformity in light emission, e.g., with respect to light intensity and/or brightness, substantially all around the lighting module. That is, it may be facilitated or enabled to achieve a lighting module capable of emitting light in a relatively large number of directions from the lighting module, or even so as to achieve a substantially omnidirectional light emission from the lighting module.

The lighting unit may be coupled to the at least a portion of one side of the first carrier substrate possibly over the entirety or substantially the entirety of the at least a portion of one side of the first carrier substrate.

A lighting module according to the first aspect may for example be included in a lighting device comprising a light-transmissive envelope at least in part enclosing the lighting module. The light-transmissive envelope may at least in part define a fluidly sealed and enclosed space within which the lighting module is arranged, and which space may include or be filled with a thermally conductive fluid, for example a gas such as air or a gas including helium and/or hydrogen. The lighting device may for example be included in or constitute a LED bulb or retrofit lamp which is connectable to a lamp or luminaire socket by way of some appropriate connector, for example an Edison screw base, a bayonet fitting, or another type of connection suitable for the lamp or luminaire known in the art. By a configuration of the tubular structure so as to exhibit such a plurality of surface portions, which allow or facilitate for an optical axis of the lighting unit or the at least one light-emitting element to become arranged at an angle with respect to a plane (substantially) perpendicular to the central, longitudinal axis of the tubular structure, any occurrence of a so called ‘dark’ region or ‘spot’ on the light-transmissive envelope may be eliminated or reduced.

A person skilled in the art will realize in the light of the present disclosure that bending of the first carrier substrate so as to achieve such a plurality of surface portions can be carried out in a number of ways. For example, as will be further described in the following, the first carrier substrate may be bent along bending lines (e.g., lines that define the center around which the first carrier substrate is bent), which may be (substantially) arranged in a zig-zag-like pattern on the one side of the first carrier substrate. As will also be further described in the following, such a zig-zag-pattern for example may be defined by way of (e.g., extend between) appropriate cut-away portions on opposing edges of the first carrier substrate, so as to achieve that a portion of the outer surface of the tubular structure (defined/formed by the plurality of surface portions) becomes similar or identical to a ‘band’ of triangles on the side faces of a polygonal antiprism shape (or a ‘band’ of another kind of polygonal surfaces). However, other ways of bending the first carrier substrate are possible, and can readily be envisaged by the skilled person in the light of the present disclosure.

Since the surface portions are part of the outer surface of the tubular structure, the surface normals of the respective surface portions are pointing outwards with respect to the tubular structure.

The second carrier substrate may for example comprise a printed circuit board (PCB) that is at least in part flexible (i.e. has at least one portion that is flexible). For example, the second carrier substrate may comprise or be constituted by a flexible foil (‘flexfoil’) and/or a flexible PCB, or by another second carrier substrate capable of or having capacity of coupling at least one light-emitting element thereto, for example to support and/or provide electrical coupling to the at least one light-emitting element.

The second carrier substrate may be configured to transfer heat, for example generated by the at least one light-emitting element when in use, away from the at least one light-emitting element. Thus the second carrier substrate may be configured so as to exhibit a heat transferring capacity and/or functionality.

In the context of the present application, by a surface normal of a surface or surface portion, it is meant a normal vector of the surface or surface portion, e.g. at some point on the surface or surface portion.

In the context of the present application, by a carrier substrate being bendable it is meant that at least a portion of the carrier substrate is bendable, i.e. that at least a portion of the carrier substrate can be bent, for example along one or more selected bending lines (e.g., lines defining the center around which the carrier substrate is bent).

The first carrier substrate may be configured to transfer heat, for example generated by the lighting unit or the at least one light-emitting element when in use, away from the lighting unit or the at least one light-emitting element and/or possibly the second carrier substrate. Thus the first carrier substrate may be configured so as to exhibit a heat transferring capacity and/or functionality.

The first carrier substrate may for example comprise one or more metallic materials, for example made of one or more metals or one or more metal alloys. The first carrier substrate may for example be made of a metallic sheet or plate, which may have a relatively small thickness.

The first carrier substrate may be bent for example by way of, or based on, means or techniques as known in the art. For example in case the first carrier substrate is metallic, it may be bent by way of, or based on, means or techniques as known in the art for forming, bending and/or shaping metallic carriers, sheets, or plates.

The first carrier substrate may be configured so as to be capable of (at least momentarily) retaining a shape attained by bending of the first carrier substrate. When the first carrier substrate is bent, the first carrier substrate may retain the bent shape (at least momentarily). Further, it may be possible to again bend the first carrier substrate, e.g. such that it obtains its original shape (or a shape close to its original shape), or any other shape.

A person skilled in the art will in the light of the present disclosure realize several possibilities for achieving or implementing a bending of the first carrier substrate such that the plurality of surface portions become configured such that at least some of the surface portions each has a surface normal that is at an angle with respect to planes perpendicular to the central, longitudinal axis and passing through the respective surface portion. For example, according to one or more embodiments of the present invention, the first carrier substrate may be bent such that the at least some of the surface portions become planar or substantially planar, or flat or substantially flat, and such that the surface portions are arranged at an angle to planes perpendicular to the central, longitudinal axis and passing through the respective surface portion.

Further, a person skilled in the art will in the light of the present disclosure realize that there are several possibilities for achieving or implementing a bending of the first carrier substrate so as to achieve a tubular structure. For example, according to one or more embodiments of the present invention, the first carrier substrate may be bent such that opposite edges of the first carrier substrate are coupled to each other, possibly by way of gluing the opposite edges together.

The first carrier substrate may be bent such that the plurality of surface portions have the same, or substantially the same, or similar, shape and/or size.

The surface portions may in principle have any shape, for example a polygonal shape such as triangular or pentagonal, but is not limited to polygonal shapes.

The first carrier substrate may be bent such that the tubular structure has at least one open end. According to one or more embodiments of the present invention, the first carrier substrate may be bent such that the tubular structure is at least in part hollow and has at least two open ends, for example so as to permit a passage of a gas or fluid such as air through the inside of the tubular structure between open ends thereof. The tubular structure may possibly have more than two ends, and be configured so as to permit passage of gas or fluid into and out of each of the respective ends.

Light-emitting elements such as LEDs may for example be arranged on or coupled to a flexible printed circuit board (PCB), a flexible foil (‘flexfoil’), or another type of second carrier substrate capable of coupling light-emitting elements such as LEDs (and/or other type(s) of solid state light sources) thereto. The second carrier substrate may then be arranged onto (e.g., wrapped around) or coupled to an outer surface of the tubular carrier. The second carrier substrate may then ‘follow’ the shape of the surface onto which it is arranged or to which it is coupled to. One way of achieving an arrangement of the LED(s) at a tilt angle with respect to the longitudinal axis of the tubular carrier for such a configuration is to employ a tubular carrier exhibiting for example a conical or truncated conical shape. However, a disadvantage with such a shape is that when wrapping a flexible PCB or foil around the tubular carrier, the flexible PCB or foil may spiral about the tubular carrier, making it difficult to achieve a regular positioning of the LEDs about the tubular carrier and/or a regular spacing between the LEDs about the tubular carrier. A regular positioning of the LEDs about the tubular carrier and/or a regular spacing between the LEDs about the tubular carrier is in general desired.

In order to address this disadvantage, the first carrier substrate may, according to one or more embodiments of the present invention, be bent such that the outer surface of the tubular structure which exhibits the plurality of surface portions defines, or includes or constitutes, at least one circumferential surface portion of the outer surface of the tubular structure. Such a configuration of the tubular structure, allows or facilitates for realizing several light-emitting elements, each having an optical axis that is at an angle with respect to planes perpendicular to the central, longitudinal axis of the tubular structure and passing through the of the tubular structure, positioned or arranged about the (possibly entire) circumference of the outer surface of the tubular structure. The first carrier substrate may for example be bent such that the plurality of surface portions form a continuous, or substantially continuous, surface. The continuous surface may for example form or define a surface corresponding to the side faces of an antiprism.

Such a circumferential surface portion, which hence may define a ‘band’ about the tubular structure, may facilitate or allow for arranging a carrier substrate in the form of a substantially rectangular, possibly sheet-, strip- or substrate-like, flexible PCB or flexible foil onto or coupled to an outer surface of the tubular structure (e.g., by wrapping the second carrier substrate around the circumferential surface portion of the tubular structure). The second carrier substrate may then ‘follow’ the shape of the surface onto which it is arranged or to which it is coupled to, but without the flexible PCB or flexible foil spiralling about the tubular structure. Thereby, it may be facilitated to achieve a regular positioning of the LEDs (and/or other light-emitting elements) about the tubular structure and/or a regular spacing between the LEDs about the tubular structure.

Thus, for the case where the lighting module (or lighting unit) comprises several light-emitting elements, coupled to (the second side of) the first carrier substrate, by bending the first carrier substrate in such a way that the plurality of surface portions form a (substantially) continuous surface, a regular positioning of the light-emitting elements may be facilitated or allowed. And perhaps even more so if the first carrier substrate is bent such that the outer surface of the tubular structure which exhibits the plurality of surface portions defines at least one circumferential surface portion of the outer surface of the tubular structure, as described in the foregoing.

In the context of the present application, by the continuous surface forming a surface corresponding to the side faces of an antiprism, it is meant that the surface has a shape similar to or the same as the surface defined or constituted by the side faces of an antiprism.

A cross section of the tubular structure in a plane perpendicular to central, longitudinal axis and passing through the continuous surface forming a surface corresponding to the side faces of an antiprism will have a polygonal shape, and the cross-sectional area of the tubular structure in all planes that are perpendicular to central, longitudinal axis and passes through the continuous surface will be the same or substantially the same.

Further in the context of the present application, by an antiprism, or n-sided antiprism, it is meant a polyhedron made up of two parallel copies of an n-sided polygon (n being an integer), making up the bases of the antiprism, and connected by an alternating ‘band’ of triangles, making up the side faces of the antiprism. Thus, an antiprism is similar to a prism, but for the antiprism, the bases are twisted relatively to each other (by some angle, often 180°/n), and the side faces are triangles, whereas in prisms, the side faces are quadrilaterals.

The first carrier substrate may for example be bent so that the plurality of surface portions form a succession of surface portions about the circumference of the tubular structure, such that adjacent surface portions have respective surface normals that are non-parallel. That is to say, adjacent surface portions may have different orientations, or in other words, have surface normals pointing in different directions.

For example, in case the at least some of the surface portions are planar or substantially planar, or flat or substantially flat, adjacent surface portions may be arranged at different angles with respect to planes perpendicular to the central, longitudinal axis and passing through the respective surface portions. For example, one of the surface portions may be oriented so as to have a surface normal pointing generally towards a first (or upper) end of the tubular structure, and an adjacent surface portion may be oriented so as to have a surface normal pointing generally towards a second (or lower) end of the tubular structure.

The first carrier substrate may be bent such that the surface normal of at least one of the surface portions which have surface normals at an angle with respect to planes perpendicular to the central, longitudinal axis and passing through the respective surface portions is non-parallel with the surface normal of another one or other ones of those surface portions. Alternatively, the surface normals of the surface portions which have surface normals at an angle with respect to planes perpendicular to the central, longitudinal axis and passing through the respective surface portions may be parallel, or substantially parallel.

The at least one light-emitting element may for example comprise at least one light-emitting diode (LED), and/or another type of solid state light source.

Thus, the lighting module may for example include one or more LEDs. However, other types of solid state light source may be included in the lighting module. Examples of solid state light sources include LEDs, organic LEDs (OLEDs), and laser diodes. Solid state light sources in general have a relatively long lifetime, and relatively low power consumption. However, in the context of the present application, the term “solid state light source” should be understood to mean substantially any device or element that is capable of emitting radiation in any region or combination of regions of the electromagnetic spectrum, for example the visible region, the infrared region, and/or the ultraviolet region, when activated e.g. by applying a potential difference across it or passing a current through it. Therefore a solid state light source can have monochromatic, quasi-monochromatic, polychromatic or broadband spectral emission characteristics. Examples of solid state light sources include semiconductor, organic, or polymer/polymeric LEDs, violet LEDs, blue LEDs, optically pumped phosphor coated LEDs, optically pumped nano-crystal LEDs or any other similar devices as would be readily understood by a person skilled in the art. Furthermore, the term solid state light source can, according to one or more embodiments of the present invention, mean a combination of the specific solid state light source or solid state light sources which emit the radiation in combination with a housing or package within which the specific solid state light source or solid state light sources are positioned or arranged. For example, the term solid state light source can encompass a bare LED die arranged in a housing, which may be referred to as a LED package.

According to a second aspect of the present invention, there is provided a lighting device which comprises a lighting module according to the first aspect. The lighting device may further include a light-transmissive envelope at least in part enclosing the lighting module. As discussed in the foregoing, the light-transmissive envelope may at least in part define a fluidly sealed and enclosed space within which the lighting module is arranged, and which space may include or be filled with a thermally conductive fluid, for example a gas such as air or a gas including helium and/or hydrogen. The lighting device may for example be included in or constitute a LED bulb or retrofit lamp which is connectable to a lamp or luminaire socket by way of some appropriate connector, for example an Edison screw base, a bayonet fitting, or another type of connection suitable for the lamp or luminaire known in the art.

According to a third aspect of the present invention, there is provided a method of manufacturing a lighting module comprising a tubular structure. The method comprises providing first carrier substrate, which is bendable and/or flexible, and providing a lighting unit. The first carrier substrate is bent so as to form a tubular structure, wherein the tubular structure is elongated, possibly at least in part hollow, and has a central, longitudinal axis. The first carrier substrate is bent such that at least a portion of one side of the first carrier substrate at least in part constitutes an outer surface of the tubular structure which exhibits a plurality of surface portions configured such that at least some of the surface portions each has a surface normal that is at an angle with respect to planes perpendicular to the central, longitudinal axis and passing through the respective surface portion. The lighting unit is coupled to the at least a portion of the one side of the first carrier substrate.

The lighting unit may for example comprise a second carrier substrate, which may be flexible and which may have a first side and a second side opposite to the first side, with the second side possibly being configured to couple at least one light-emitting element thereto. The coupling of the lighting unit to the at least a portion of the one side of the first carrier substrate may comprise coupling the first side of the second carrier substrate to the at least a portion of one side of the first carrier substrate.

According to one or more embodiments of the present invention, the coupling of the first side of the second carrier substrate to the at least a portion of the one side of the first carrier substrate may for example comprise wrapping the second carrier substrate about the outer surface of the tubular structure.

According to one or more embodiments of the present invention, the (first side of the) second carrier substrate may for example be glued to the at least a portion of the one side of the first carrier substrate.

The coupling of the lighting unit to the at least a portion of the one side of the first carrier substrate may according to one or more embodiments of the present invention be carried out prior to bending the first carrier substrate so as to form the tubular structure. That is to say, the lighting unit may first be coupled to the at least a portion of the one side of the first carrier substrate, and then the first carrier substrate (with at least a portion of the lighting unit being coupled thereto) may be bent.

According to one or more embodiments of the present invention, the coupling of the first side of the second carrier substrate to the at least a portion of the one side of the first carrier substrate may be carried out prior to bending the first carrier substrate so as to form the tubular structure. That is to say, the second carrier substrate may first be coupled to the first carrier substrate, and then the first carrier substrate (with the second carrier substrate being coupled thereto) may be bent.

Prior to bending the first carrier substrate so as to form the tubular structure, the first carrier substrate may be substantially planar.

A plurality of first cutaway portions may be provided at least in part on a first side edge of the first carrier substrate, the plurality of first cutaway portions being arranged in spaced relation relatively to each other.

A plurality of second cutaway portions may be provided at least in part on a second side edge of the first carrier substrate, the second side edge of the first carrier substrate being arranged opposite to the first side edge of the first carrier substrate and substantially parallel therewith, and the plurality of second cutaway portions being arranged in spaced relation relatively to each other.

Each of the first and second cutaway portions may have an extension into the first carrier substrate and ends in an inner point of the first carrier substrate. The extensions of the first and second cutaway portions into the first carrier substrate may be such that the first carrier substrate is continuous between the first and second rows. The inner points of the first cutaway portions may be arranged in a first row and the inner points of the second cutaway portions are arranged in a second row, which may be parallel or substantially parallel to the first row. The inner points of the first row may be staggered in relation to the inner points of the second row. The first and second rows may for example extend in directions parallel to the first and second edge.

According to one or more embodiments of the present invention, the bending of the first carrier substrate so as to form the tubular structure may comprise, for each inner point of one of the first or second row, bending the first carrier substrate along the line or lines between the inner point and any adjacent, staggered inner point in the other row.

In the context of the present application, by inner points of the first row being staggered in relation to the inner points of the second row (e.g., in a direction parallel to the first and second edges), it is meant that the inner points of the first row and the inner points of the second row are arranged in a staggered pattern. That is to say, at least some of the inner points in one of the first and second rows are positioned within the spacings between the inner points in the other row (possibly as seen in the direction parallel to the first and second edges). For example, at least some of the inner points in one of the first and second rows may be positioned (approximately) in the middle of the spacings between the inner points in the other row (e.g., as seen in the direction parallel to the first and second edges).

The first and second cutaway portions may be implemented in different shapes. For example, according to one or more embodiments of the present invention, at least some of the first and second cutaway portions may be triangular when viewed along a direction perpendicular to the first carrier substrate prior to bending the first carrier substrate so as to form the tubular structure.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the invention will be described below with reference to the accompanying drawings.

FIG. 1 is a schematic view of a lighting module according to an embodiment of the present invention.

FIGS. 2, 3 and 4 are schematic views of a first carrier substrate in accordance with an embodiment of the present invention.

FIG. 5 is a schematic cross-sectional side view of a lighting device according to an embodiment of the present invention.

FIGS. 6 and 7 are schematic views of first carrier substrates according to different embodiments of the present invention.

FIG. 8 is a schematic flowchart of a method according to an embodiment of the present invention for manufacturing a lighting module.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art.

In the drawings, identical reference numerals denote the same or similar components having a same or similar function, unless specifically stated otherwise.

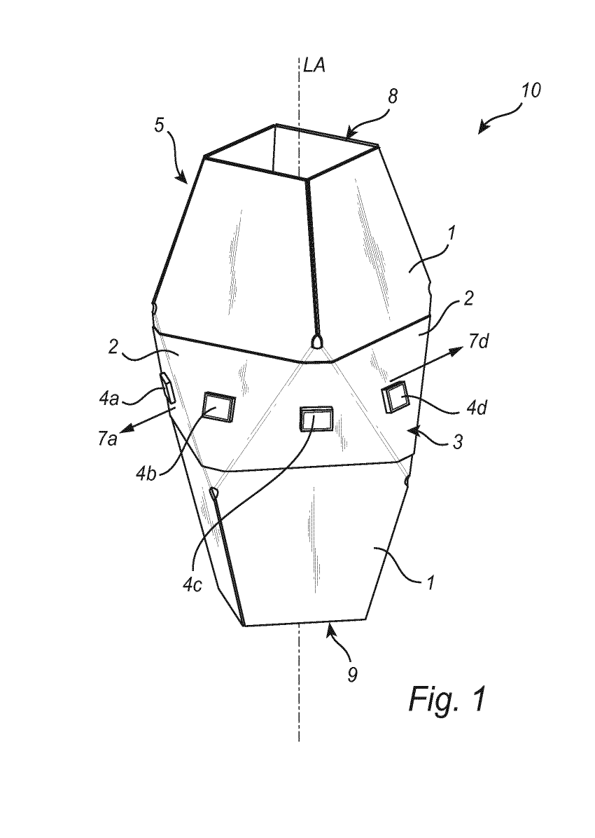

FIG. 1 is a schematic view of a lighting module 10 according to an embodiment of the present invention. The lighting module 10 comprises a first carrier substrate 1, which is bendable. The lighting module 10 further comprises a lighting unit 2, 4a-4d, which in accordance with the embodiment of the present invention illustrated in FIG. 1 comprises a second carrier substrate 2. The second carrier substrate 2 is flexible, and has a first side (not shown in FIG. 1) and a second side 3 opposite to the first side. The first side of the second carrier substrate 2 is coupled to a portion of one side of the first carrier substrate 1 (the portion of the side of the first carrier substrate 1 to which the second carrier substrate 2 is coupled is beneath the second carrier substrate 2 illustrated in FIG. 1). The second side 3 of the second carrier substrate 2 is configured to couple light-emitting elements 4a-4d thereto. Although FIG. 1 depicts four light-emitting elements 4a-4d coupled to the second side 3 of the second carrier substrate 2, it is understood that this number of light-emitting elements is according to an exemplifying embodiment of the present invention, and that more or fewer light-emitting elements may be included in the lighting module 10. For example, one, two, three, five, six or ten or even more light-emitting elements may be included in the lighting module 10.

The first carrier substrate 1 may for example be metallic, and may comprise one or more metallic materials such as one or more metals and/or metal alloys. The first carrier substrate 1 may for example be made of a relatively thin metallic sheet or plate. The second carrier substrate 2 may for example comprise an at least in part flexible, printed circuit board (PCB), or a flexible foil, and/or some other type of flexible carrier substrate capable of coupling at least one light-emitting element thereto.

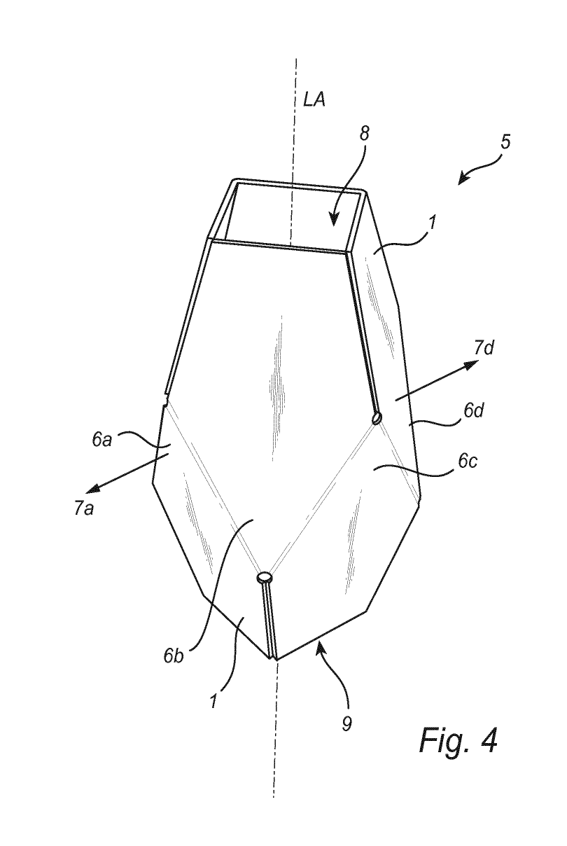

The first carrier substrate 1 has been bent so as to form a tubular structure 5. The tubular structure 5 is elongated, hollow, and has a central, longitudinal axis LA. The first carrier substrate 1 has been bent such that the portion of the one side of the first carrier substrate 1 (i.e. the portion of the side of the first carrier substrate 1 to which the second carrier substrate 2 is coupled) in part constitutes an outer surface of the tubular structure 5 which exhibits surface portions 6a-6d (the outer surface and surface portions 6a-6d are not indicated by reference numerals in FIG. 1—see FIG. 4) configured such that the surface portions 6a-6d each has a surface normal 7a, 7d (only the surface normals of the surface portions 6a and 6d are shown in FIG. 1) that is at an angle with respect to planes perpendicular to the central, longitudinal axis LA and passing through the respective surface portion 6a-6d. Such (imaginary) planes are not shown in FIG. 1. Thus, the second carrier substrate 2 is coupled to the outer surface of the tubular structure 5 at the surface portions 6a-6d thereof.

According to one or more embodiments of the present invention, the surface portions 6a-6d may for example be configured such that the surface portions 6a-6d each has a surface normal 7a, 7d that is at an angle within a range from about 10° to about 25°, or from about 15° to about 20°, with respect to planes perpendicular to the central, longitudinal axis LA and passing through the respective surface portion 6a-6d. However, other ranges of angles are contemplated, for example below 10° or 15°, or above 20° or 25°.

As indicated in FIG. 1, the first carrier substrate 1 may, according to one or more embodiments of the present invention, be bent such that the outer surface of the tubular structure 5 exhibiting the surface portions 6a-6d defines a circumferential surface portion of the outer surface of the tubular structure 5, in the form of a ‘band’ which goes around the tubular structure 5. Note that only some of the surface portions 6a-6d in the ‘band’ are shown in FIG. 1.

Further in accordance with the embodiment of the present invention illustrated in FIG. 1, the first carrier substrate 1 has been bent such that the surface portions 6a-6d form a continuous, or substantially continuous, surface. According to the embodiment of the present invention illustrated in FIG. 1, the continuous surface (that is to say, the portion of the outer surface of the tubular structure 5 which exhibits the surface portions 6a-6d and to which the second carrier substrate 2 is coupled) has a shape according to the side faces of an antiprism. However, other ways of bending the first carrier substrate are possible, and can readily be envisaged by the skilled person in the light of the present disclosure. Accordingly, it is to be understood that the shape, the size as well as the number of surface portions 6a-6d of the outer surface of the tubular structure 5 illustrated in FIG. 1 are according to an exemplifying embodiment of the present invention, and that other shapes, sizes and/or numbers of surface portions are possible.

As illustrated in FIG. 1, the tubular structure 5 has, according to one or more embodiments of the present invention, an inner surface formed by the side of the first carrier substrate 1 which is opposite to the side of the first carrier substrate 1 to which the second carrier substrate 2 is coupled to. According to the embodiment of the present invention illustrated in FIG. 1, the inner surface at least in part defines, or delimits, a region within the tubular structure 5 defined by a cavity including or being constituted by an open void.

Further, the tubular structure 5 may have, according to one or more embodiments of the present invention and such as illustrated in FIG. 1, two open ends 8, 9. Thereby, the region within the tubular structure 5 allows for guiding light therein and also permits any fluid or gas such as air to pass through the tubular structure 5, between the open ends 8, 9.

According to one or more embodiments of the present invention (which are not illustrated in the drawings), the region within the tubular structure 5 may be hollow at least in part. The region within the tubular structure 5 may include or be constituted by a structure and/or one or more materials which permit passage of fluid through the region within the tubular structure 5, and possibly at the same time also permitting propagation or conveyance of light in the region within the tubular structure 5. The one or more materials of the region within the tubular structure 5 may at least in part include a transparent material, allowing light to pass through the material (substantially) without being scattered. The one or more materials of the region within the tubular structure 5 could for example include a porous material, i.e. a material containing pores, or voids.

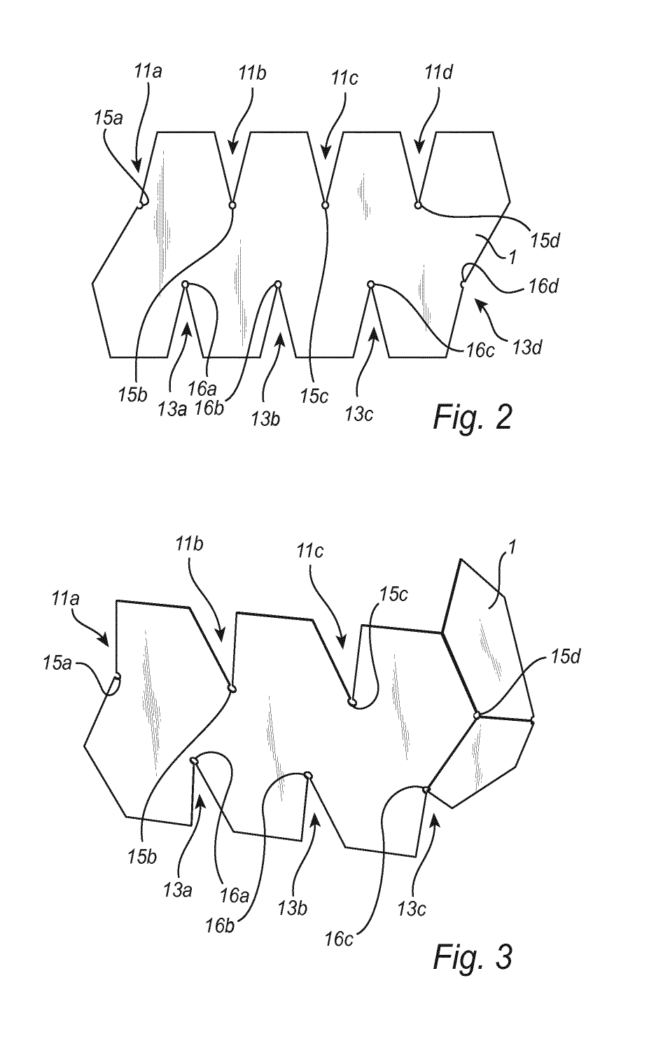

FIGS. 2 and 3 are schematic views of a first carrier substrate 1 in accordance with an embodiment of the present invention, prior to being bent and at an intermediate stage in a process of bending the first carrier substrate 1 so as to form a tubular structure (such as illustrated in FIG. 1), respectively. Bending of the first carrier substrate 1 so as to achieve surface portions 6a-6d such as described in the foregoing with reference to FIG. 1 can be carried out in a number of ways. For example, the first carrier substrate 1 may be bent along bending lines (which may be straight or curved) which form or define a ‘zig-zag pattern’ on the one side of the first carrier substrate 1 (i.e. the side of the first carrier substrate 1 to which the second carrier substrate 2 is coupled). As will be described in more detail in the following with reference to FIGS. 2 to 4, such a zig-zag-pattern may for example extend between appropriately configured cut-away portions on opposing edges of the first carrier substrate 1, so as to achieve that the portion of the outer surface of the tubular structure 5 which exhibits the surface portions 6a-6d becomes similar or identical to a ‘band’ of triangles on the side faces of a polygonal antiprism shape. However, other ways of bending the first carrier substrate 1 are possible, and can readily be envisaged by the skilled person in the light of the present disclosure.

In FIGS. 2 and 3, the second carrier substrate 2 has not been coupled to the one side of the first carrier substrate 1. However, according to one or more embodiments of the present invention, coupling of the first side of the second carrier substrate 2 to the portion of the one side of the first carrier substrate 1 may be carried out prior to bending the first carrier substrate 1 so as to form the tubular structure 5. Coupling of the second carrier substrate 2 to the first carrier substrate 1 may for example be carried out by way of gluing them together. In alternative or in addition, some other appropriate coupling means other than glue as known in the art may be employed for coupling the second carrier substrate 2 to the first carrier substrate 1, or vice versa.

As indicated in FIG. 2, the first carrier substrate 1 may be planar (e.g., plate- or sheet-like) prior to it being bent so as to form the tubular structure 5. Thus, the tubular structure 5 can be formed for example by bending of a flat piece of material.

As illustrated in FIG. 2, there may be provided a plurality of first cutaway portions 11a-11d at least in part on a first side edge 12 of the first carrier substrate 1. The first cutaway portions 11a-11d are arranged in spaced relation relatively to each other such as shown in FIG. 2. Further, there may be provided a plurality of second cutaway portions 13a-13d at least in part on a second side edge 14 of the first carrier substrate 1, with the second side edge 14 of the first carrier substrate 1 being arranged opposite to the first side edge 12 of the first carrier substrate 1, and possibly substantially parallel therewith. Similarly to the first cutaway portions 11a-11d, the second cutaway portions 13a-13d are arranged in spaced relation relatively to each other. Each of the first and second cutaway portions 11a-11d, 13a-13d has an extension into the first carrier substrate 1 (according to the embodiment illustrated in FIG. 2, the extensions of the first and second cutaway portions 11a-11d, 13a-13d into the first carrier substrate 1 are the same), and ends in an inner point 15a-15d, 16a-16d of the first carrier substrate 1. The inner points 15a-15d of the first cutaway portions 11a-11d are arranged in a first row. The inner points 16a-16d of the second cutaway portions 13a-13d are arranged in a second row, which is parallel to the first row. It is to be understood that the first and second rows need not necessarily be exactly parallel, but that there may be an angle between the directions in which the first and second rows extend, e.g. up to one or a few degrees or even more. The inner points 15a-15d of the first row are staggered in relation to the inner points 16a-16d of the second row, or vice versa. The staggering of the inner points 15a-15d of the first row in relation to the inner points 16a-16d of the second row, or vice versa, may for example be in a direction parallel to the first and second edges 12 and 14.

The bending of the first carrier substrate 1 so as to form the tubular structure 5 may comprise, for each inner point 15a-15d, 16a-16d of one of the first or second row, bending the first carrier substrate 1 along the line or lines between the inner point 15a-15d, 16a-16d and any adjacent, staggered inner point 15a-15d, 16a-16d in the other row.

FIG. 3 illustrates an intermediate stage in a process of bending the first carrier substrate 1 some as to form a tubular structure (such as illustrated in FIG. 1), where the first carrier substrate 1 has been bent along lines between the inner point 15d of the first (upper) row of inner points 15a-15d shown in FIG. 2 and the inner points 16c and 16d in the second (lower) row, respectively, shown in FIG. 2. The process of bending the first carrier substrate 1 so as to form a tubular structure may further include bending the first carrier substrate 1 along lines between the inner point 15c of the first (upper) row of inner points 15a-15d shown in FIG. 2 and the inner points 16b and 16b in the second (lower) row, respectively, shown in FIG. 2, and so on. Thereby, a tubular structure 5 having a shape such as the one illustrated in FIG. 1 can be formed.

FIG. 4 is a schematic view of a first carrier substrate 1 in accordance with an embodiment of the present invention, having been bent so as to form a tubular structure 5 having a shape such as the one illustrated in FIG. 1, and such as described in the foregoing with reference to FIGS. 2 and 3. The first carrier substrate 1 has been bent such that opposite edges of the first carrier substrate 1 can be coupled or fixed to each other, possibly by way of gluing the opposite edges together. Only some of the surface portions 6a-6d are shown in FIG. 4.

In accordance with the embodiment of the present invention illustrated in FIGS. 2 and 3, the first and second cutaway portions 11b-11d, 13a-13c are triangular when viewed along a direction perpendicular to the first carrier substrate 1 prior to bending the first carrier substrate 1 so as to form the tubular structure 5 (cf. FIG. 2). That is to say, the first and second cutaway portions 11b-11d, 13a-13c may have a V-shape. However, other shapes of the first and second cutaway portions 11b-11d, 13a-13c are contemplated.

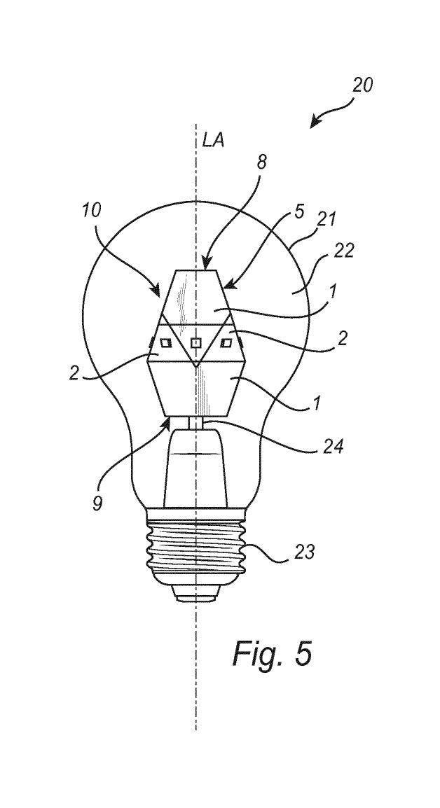

FIG. 5 is a schematic cross-sectional side view of a lighting device 20 according to an embodiment of the present invention. The lighting device 20 comprises a lighting module 10 and a light-transmissive envelope 21 which encloses the lighting module 10. In accordance with the embodiment of the present invention illustrated in FIG. 1, the light-transmissive envelope 21 is bulb-shaped. However, the bulb-shape of the light-transmissive envelope 21 depicted in FIG. 5 is according to an example. Other shapes of the light-transmissive envelope 21 are possible, and the light-transmissive envelope 21 may in principle have any shape. The light-transmissive envelope 21 may at least in part define an enclosed space 22 within which the lighting module 10 is arranged. The light-transmissive envelope 21 may be configured such that the space 22 is a fluidly sealed space, and which space may include or be filled with air or a thermally conductive fluid, for example a gas including helium and/or hydrogen. The thermally conductive gas or fluid (e.g. including helium and/or hydrogen) may be combined with a certain content of e.g. oxygen. In accordance with the embodiment of the present invention illustrated in FIG. 5, the lighting device 20 may comprise a base 23 for connection to a lamp or luminaire socket (not shown in FIG. 5). The base 23 may include or be constituted by any suitable type of coupler or connector, for example an Edison screw base, a bayonet fitting, or any other type of connection which may be suitable for the particular type of lamp or luminaire.

As discussed above with reference to FIG. 1, the tubular structure 5 may have, according to one or more embodiments of the present invention and such as illustrated in FIG. 1, two open ends 8, 9. Thereby, the region within the tubular structure 5 may permit any fluid or gas such as air to pass through the tubular structure 5, between and into and out of the open ends 8, 9. Thereby, a flow of circulation of fluid, e.g. a gas such as air or helium, through the tubular structure 5 may be facilitated or even enabled. Thereby the tubular structure 5 may provide functionality similar to that of a chimney, facilitating or allowing for heat transport by way of convection to take place within the tubular structure 5 by a continuous circulation of fluid through the region within the tubular structure 5. A flow of circulation of fluid through the tubular structure 5 may be achieved also with the tubular structure 5 having a single open end, or more than two open ends.

According to the embodiment of the present invention illustrated in FIG. 5, the longitudinal axis LA of the lighting module 10 (substantially) coincides with a longitudinal axis of the lighting device 20. Further according to the embodiment of the present invention illustrated in FIG. 5, the longitudinal axis LA may be an axis of rotational symmetry of the lighting module 10 and/or the lighting device 20.

As indicated in FIG. 5, the lighting device 20 (or lighting module 10) may include some kind of support structure for supporting the lighting module 10 in the lighting device 20. According to the embodiment illustrated in FIG. 5, such a support structure may for example comprise a stem or the like 24 connected to the base 23, which stem may extend for example along the longitudinal axis LA into the tubular structure 5, and which stem 24 may have support rods or the like (not shown in FIG. 5) extending laterally from the stem 24 within the tubular structure 5 and being coupled to an inner surface of the tubular structure 5. However, such a support structure is not necessary. For example, the light-transmissive envelope 21 could be configured or shaped such that a portion of its inner surface could be used to support the lighting module 10 and possibly allow the lighting module 10 to be coupled or connected to the inner surface of the light-transmissive envelope 21. For example, the light-transmissive envelope 21 may be configured or shaped so that its inner surface exhibits protrusions which may support the lighting module 10 or to which the lighting module 10 could be coupled or connected.

As known in the art, the lighting device 20 may include circuitry capable of converting electricity from a power supply to electricity suitable to operate or drive the light-emitting elements 4a-4d and/or power any other electrical component that may be included in the lighting device 20. Such circuitry, which is not shown in FIG. 5, may be capable of at least converting between Alternating Current and Direct Current and converting voltage into a suitable voltage for operating or driving the light-emitting elements 4a-4d.

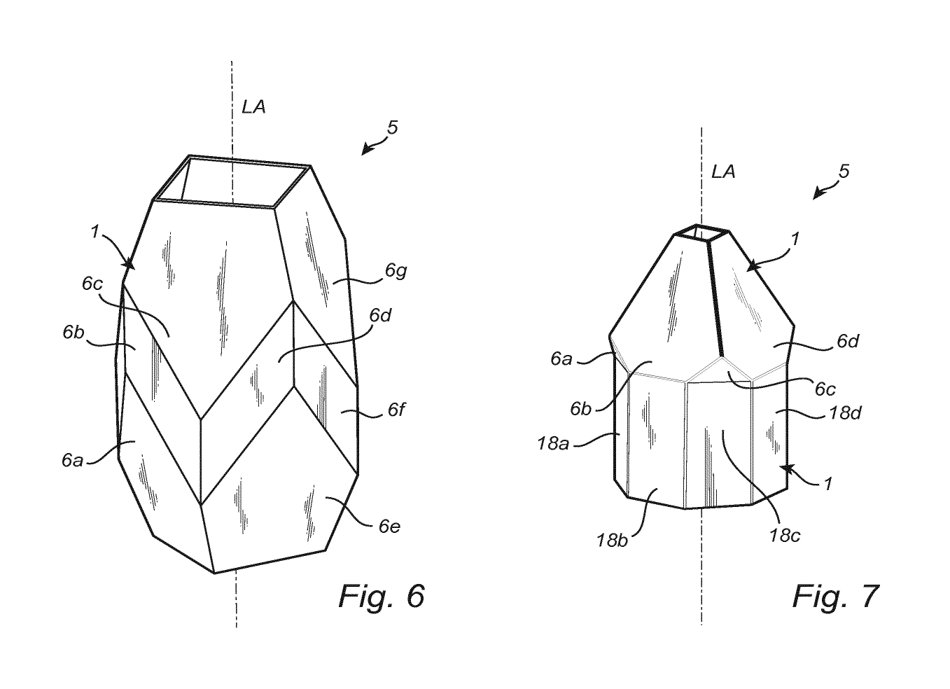

FIG. 6 is a schematic view of a first carrier substrate 1 in accordance with an embodiment of the present invention, having been bent so as to form a tubular structure 5, similarly to the first carrier substrate 1 illustrated in FIG. 4. According to the embodiment of the present invention illustrated in FIG. 6, the outer surface of the tubular structure 5 exhibits a plurality of surface portions 6a-6g (of which only some are shown in FIG. 6) configured such that the surface portions 6a-6g each has a surface normal that is at an angle with respect to planes perpendicular to the central, longitudinal axis LA and passing through the respective surface portion 6a-6g.

FIG. 7 is a schematic view of a first carrier substrate 1 in accordance with an embodiment of the present invention, which has been bent so as to form a tubular structure 5, similarly to the first carrier substrates 1 illustrated in FIGS. 4 and 6. According to the embodiment of the present invention illustrated in FIG. 7, the outer surface of the tubular structure 5 exhibits a plurality of surface portions 6a-6d (of which only some are shown in FIG. 7) configured such that the surface portions 6a-6d each has a surface normal that is at an angle with respect to planes perpendicular to the central, longitudinal axis LA and passing through the respective surface portion 6a-6d. Further according to the embodiment of the present invention illustrated in FIG. 7, the outer surface of the tubular structure 5 in addition comprises a plurality of surface portions 18a-18d (of which only some are shown in FIG. 7) that have surface normals that are lying in a plane (substantially) perpendicular with respect to the central, longitudinal axis LA. For example, and in accordance with the embodiment of the present invention illustrated in FIG. 7, the surface portions 18a-18d may form a surface corresponding to the side faces of octagonal prism. A flexible, second carrier substrate (not shown in FIG. 7) can be coupled to the outer surface of the tubular structure 5 at both the surface portions 6a-6d and at at least a portion of the surface portions 18a-18d. Thus, a lighting module (cf. FIG. 1 and the description herein referring thereto) which includes a tubular structure 5 such as illustrated in FIG. 7 may be capable of emitting light both along an optical axis or optical axes lying in a plane which is (substantially) perpendicular to the central, longitudinal axis LA of the tubular structure 5, as well as along an optical axis or optical axes that are not lying in that plane but which are arranged at angles with respect to that plane.

As indicated in FIG. 7, the tubular structure 5 may comprise in accordance with one or more embodiments of the present invention comprise several first carrier substrates (for example, with one first carrier substrate including the surface portions 6a-6d, and a second first carrier substrate including the surface portions 18a-18d), which may be interconnected.

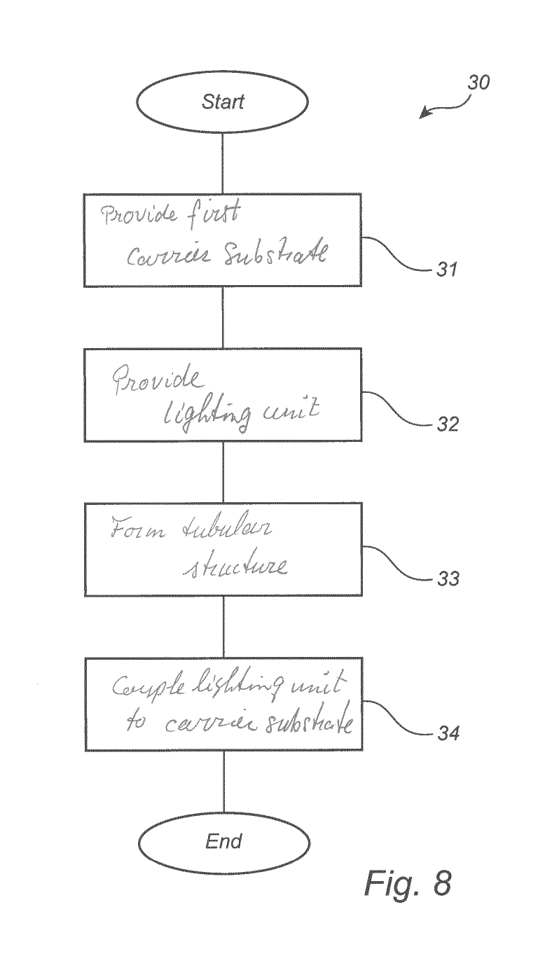

FIG. 8 is a schematic flowchart of a method 30 according to an embodiment of the present invention, the method 30 being for manufacturing a lighting module comprising a tubular structure. The method 30 comprises providing first carrier substrate, 31, which first carrier substrate is bendable and/or flexible. A lighting unit, which according to the embodiment illustrated in FIG. 8 comprises a second carrier substrate, is provided, 32, which second carrier substrate is flexible and has a first side and a second side opposite to the first side, the second side being configured to couple at least one light-emitting element thereto. The first carrier substrate is bent so as to form a tubular structure, 33, wherein the tubular structure is elongated, possibly at least in part hollow, and has a central, longitudinal axis. The first carrier substrate is bent such that at least a portion of one side of the first carrier substrate at least in part constitutes an outer surface of the tubular structure which exhibits a plurality of surface portions configured such that at least some of the surface portions each has a surface normal that is at an angle with respect to planes perpendicular to the central, longitudinal axis and passing through the respective surface portion. The lighting unit is coupled to the at least a portion of the one side of the first carrier substrate, 34. According to the embodiment illustrated in FIG. 8, the coupling to the lighting unit to the at least a portion of the one side of the first carrier substrate comprises coupling the first side of the second carrier substrate to the at least a portion of the one side of the first carrier substrate.

As indicated in FIG. 8, the step 34 may be carried out after step 33 has been carried out. However, this is not necessary. For example, according to one or more embodiments of the present invention, the coupling of the first side of the second carrier substrate to the at least a portion of the one side of the first carrier substrate may be carried out prior to bending the first carrier substrate so as to form the tubular structure.

In conclusion there is disclosed a lighting module, which comprises a bendable first carrier substrate and a lighting unit. The first carrier substrate is bendable. The first carrier substrate is bent so as to form a tubular structure, which is elongated and possibly at least in part hollow, and has a central, longitudinal axis. At least a portion of one side of the first carrier substrate at least in part constitutes an outer surface of the tubular structure exhibiting a plurality of surface portions, with the plurality of surface portions configured such that at least some of the surface portions each has a surface normal that is at an angle with respect to planes perpendicular to the central, longitudinal axis and passing through the respective surface portion. The lighting unit is coupled to the at least a portion of the one side of the first carrier substrate. By way of the geometrical configuration of the plurality of surface portions, the lighting unit and possibly at least one light-emitting element included therein may have a main direction of light emission that is at an angle with respect to a plane that is passing through the tubular structure and that is substantially perpendicular to the central, longitudinal axis of the tubular structure.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A lighting module comprising:
a first carrier substrate that is bendable; and
a lighting unit coupled to at least a portion of one side of the first carrier substrate;
the first carrier substrate being bent so as to form a tubular structure, the tubular structure being elongated, at least in part hollow, and having a central, longitudinal axis, such that the at least a portion of the one side of the first carrier substrate at least in part constitutes an outer surface of the tubular structure which exhibits a plurality of surface portions configured such that at least some of the surface portions each has a surface normal that is at an angle with respect to planes perpendicular to the central, longitudinal axis and passing through the respective surface portion,
wherein the first carrier substrate is bent such that the plurality of surface portions form a continuous surface and wherein the continuous surface forms a surface corresponding to the side faces of an antiprism,
wherein the lighting unit comprises a second carrier substrate that is flexible and which has a first side and a second side opposite to the first side, the first side being coupled to the at least a portion of one side of the first carrier substrate, and the second side being configured to couple at least one light-emitting element thereto.

2. (canceled)

3. A lighting module according to claim 1, wherein the at least some of the surface portions are planar.

4. A lighting module according to claim 1, wherein the first carrier substrate is bent such that the outer surface of the tubular structure which exhibits the plurality of surface portions defines at least one circumferential surface portion of the outer surface of the tubular structure.

5. A lighting module according to claim 4, wherein the plurality of surface portions form a succession of surface portions about the circumference of the tubular structure such that adjacent surface portions have respective surface normals that are non-parallel.

6. A lighting module according to any claim 1, wherein the first carrier substrate is bent such that the surface normal of at least one of the surface portions which have surface normals at an angle with respect to planes perpendicular to the central, longitudinal axis and passing through the respective surface portions is non-parallel with the surface normal of another one or other ones of those surface portions.

7. A lighting module according to claim 1, wherein the first carrier substrate is bent such that opposite edges of the first carrier substrate are coupled to each other.

8. A lighting module according to claim 1, wherein the first carrier substrate is bent such that the tubular structure has at least one open end.

9. A lighting device comprising:
a lighting module according to claim 1; and
a light-transmissive envelope at least in part enclosing the lighting module.

10. A method of manufacturing a lighting module comprising a tubular structure, the method comprising:
providing a first carrier substrate, the first carrier substrate being bendable;
providing a lighting unit;
bending the first carrier substrate so as to form the tubular structure, the tubular structure being elongated, at least in part hollow, and having a central, longitudinal axis, such that at least a portion of one side of the first carrier substrate at least in part constitutes an outer surface of the tubular structure which exhibits a plurality of surface portions configured such that at least some of the surface portions each has a surface normal that is at an angle with respect to planes perpendicular to the central, longitudinal axis and passing through the respective surface portion wherein the first carrier substrate is bent such that the plurality of surface portions form a continuous surface and wherein the continuous surface forms a surface corresponding to the side faces of an antiprism; and
coupling the lighting unit to the at least a portion of the one side of the first carrier substrate,
wherein the lighting unit comprises a second carrier substrate, the second carrier substrate being flexible and having a first side and a second side opposite to the first side whereby the second carrier substrate follows the first carrier substrate by wrapping it around the first carrier substrate, the second side being configured to couple at least one light-emitting element thereto, and wherein the coupling of the lighting unit to the at least a portion of the one side of the first carrier substrate comprises coupling the first side of the second carrier substrate to the at least a portion of one side of the first carrier substrate.

11. (canceled)

12. A method according to claim 10, wherein the coupling of the lighting unit to the at least a portion of the one side of the first carrier substrate is carried out prior to bending the first carrier substrate so as to form the tubular structure.

13. A method according to claim 10, wherein prior to bending the first carrier substrate so as to form the tubular structure, the first carrier substrate is planar; and wherein the method further comprises:
providing a plurality of first cutaway portions at least in part on a first side edge of the first carrier substrate, the plurality of first cutaway portions being arranged in spaced relation relatively to each other; and
providing a plurality of second cutaway portions at least in part on a second side edge of the first carrier substrate, the second side edge of the first carrier substrate being arranged opposite to the first side edge of the first carrier substrate and substantially parallel therewith, and the plurality of second cutaway portions being arranged in spaced relation relatively to each other;
wherein each of the first and second cutaway portions has an extension into the first carrier substrate and ends in an inner point of the first carrier substrate, and wherein the inner points of the first cutaway portions are arranged in a first row and the inner points of the second cutaway portions are arranged in a second row parallel to the first row, and the inner points of the first row are staggered in relation to the inner points of the second row, or vice versa;
wherein the bending of the first carrier substrate so as to form the tubular structure comprises:
for each inner point of one of the first or second row, bending the first carrier substrate along the line or lines between the inner point and any adjacent, staggered inner point in the other row.
